(19) United States
(12) Patent Application Publication
(10) Pub. No.: US 2010/0301802 A1
(43) Pub. Date: Dec. 2, 2010

(54) CHARGING APPARATUS

(75) Inventor: Takahide Iida, Aichi-ken (JP)

Correspondence Address: GREENBLUM & BERNSTEIN, P.L.C., 1950 ROLAND CLARKE PLACE, RESTON, VA, 20191, US

(73) Assignee: KABUSHIKI KAISHA TOYOTA JIDOSHOKKI, Aichi-ken (JP)

(21) Appl. No.: 12/787,438

(22) Filed: May 26, 2010

(30) Foreign Application Priority Data
Jun. 2, 2009 (JP) 2009-132638

(51) Int. Cl. H02J 7/00

(52) U.S. Cl. 320/109

(57) ABSTRACT

The charging apparatus supplying power from a power source to a vehicle includes a body, a cable, a communication device, a starting switch and a controller. The controller is connected to the communication device and the starting switch for controlling the power supply from the power source to the charging connector. If the charging connector is connected to a vehicle which has no communication function for communicating with the charging apparatus, the controller controls so that a voltage is applied to the charging connector when the starting switch is operated. If the charging connector is connected to a vehicle which has communication function for communicating with the charging apparatus, the controller controls so that a voltage is applied to the charging connector in accordance with the communication between the communication device and the vehicle.

### BACKGROUND OF THE INVENTION

The present invention relates to a charging apparatus used to charge an electric vehicle or a plug-in hybrid vehicle.

FIG. 8 shows two types of charging apparatuses for charging an electric vehicle or a plug-in hybrid vehicle, namely a charging pole 51 having a socket outlet 51A only and a charging station 53 having a charging cable 53A. Vehicle charging by the charging pole 51 is accomplished by inserting the plug at one end of its detachable cable 52 into the socket outlet 51A and connecting the charging connector at the other end of the detachable cable 52 to the vehicle. Vehicle charging by the charging station 53 is accomplished by connecting the charging connector of the charging cable 53A fixed to the charging station 53 to the vehicle. The charging pole 51 uses the detachable cable 52 which is supported by the mode 1 charging or mode 2 charging given in the IEC 61851-1 standard of the International Electrotechnical Commission. The charging station 53 uses the charging cable 53A which is supported by the mode 3 charging given in the IEC 61851-1 standard. In the case of the mode 1 charging, a detachable cable is used. For the mode 2 charging, a detachable cable having a leakage detector is used. For the mode 3 charging, a cable fixed to a charging station is used.

Japanese Patent Application Publication No. 10-304582 discloses an inductive charging apparatus that charges a battery by using inductive current flowing through the charging coil of the vehicle that is magnetically coupled to the feeder coil of the infrastructure. Such inductive charging is similar to the mode 3 charging in that charging information is communicated between the communication device of the infrastructure and the RF board of the vehicle. Japanese Patent Application Publication No. 2009-71989 discloses a vehicle charge controller having a charging cable that connects a plug-in hybrid vehicle and an external power source. This charging cable is similar to the cable for the mode 2 charging.

Referring back to FIG. 8, in the case of charging a vehicle by the charging station 53, the charging cable 53A is simply connected to the vehicle and transferring charging information between the charging cable 53A and the vehicle is accomplished via communication function. In the case of charging by the charging pole 51, on the other hand, the plug at one end of the detachable cable 52 is connected to the socket outlet 51A of the charging pole 51 and the charging connector at the other end of the detachable cable 52 is connected to the vehicle. If the detachable cable 52 has no communication function, it is supported by the mode 1 charging. If the detachable cable 52 has communication function, it is supported by the mode 2 charging.

As shown in FIG. 8, the charging pole 51 and the charging station 53 may be integrated thereby to form a charging station 54, which may reduce the price and the installation cost. The integrated charging station 54 has both a socket outlet 54A and an undetachable cable 54B. When the socket outlet 54A is used for charging, a detachable cable 55 which is supported by the mode 1 charging is used for connection between the charging station 54 and a vehicle. The undetachable cable 54B is supported by the mode 3 charging. The vehicle A of FIG. 8 having no communication function is charged using the detachable cable 55 supported by the mode 1 charging. The vehicle B of FIG. 8 having communication function is charged using the undetachable cable 54B supported by the mode 2 or 3 charging. In the charging station 54, a standardized connector is used for connecting the detachable cable 55 to the vehicle and also connecting the undetachable cable 54B to the vehicle. The standardized connector is used in any of the above-described modes 1 to 3 charging. Such an integrated charging station 54 has problems in charging the vehicles A and B. Specifically, although the vehicle A is charged by connecting the plug of the detachable cable 55 to the socket outlet 54A of the charging station 54 and the charging connector of the detachable cable 55 to the vehicle A, the vehicle B is not charged by the same connection of the detachable cable 55 between the socket outlet 54A and the vehicle B. Although the vehicle B is charged by connecting the charging connector of the undetachable cable 54B to the vehicle B, the vehicle A is not charged by the same connection of the undetachable cable 54B between the charging station 54 and the vehicle A.

In the case of the detachable cable 55, which is supported by the mode 1 charging, the vehicle A, which is charged according to the mode 1 charging, is charged simply by connecting the detachable cable 55 to the vehicle A. However, the vehicle B, which is charged according to the mode 2 or 3 charging, is not charged by connecting the detachable cable 55 to the vehicle B because charging information is not communicated between the detachable cable 55 and the vehicle B. In the case of the undetachable cable 54B, which is supported by the mode 3 charging, on the other hand, the vehicle B, which is charged according to the mode 2 or 3 charging, is charged simply by connecting the undetachable cable 54B to the vehicle B because charging information is communicated between the undetachable cable 54B and the vehicle B. However, the vehicle A is not charged by connecting the undetachable cable 54B to the vehicle A because charging information is not communicated between the undetachable cable 54B and the vehicle A. Thus, the charging station 54 using the standardized connector cannot charge a vehicle in some cases, which may cause inconvenience to the users of the charging station 54.

The present invention, which has been made in light of the above-described problems, is directed to a charging apparatus which permits charging of any vehicle by using a standardized connector.

### SUMMARY OF THE INVENTION

In accordance with an aspect of the present invention, there is provided a charging apparatus supplying power from a power source to a vehicle. The charging apparatus includes a body, a cable, a communication device, a starting switch and a controller. One end of the cable is fixed to the body and the other end of the cable has a standardized charging connector that is connectable to the vehicle. The communication device is provided for communicating charging information with the vehicle which has communication function for communicating with the charging apparatus. The starting switch is provided in the body for starting charging the vehicle. The controller is connected to the communication device and the starting switch for controlling the power supply from the power source to the charging connector. If the charging connector is connected to a vehicle which has no communication function for communicating with the charging apparatus, the controller controls so that a voltage is applied to the charging connector when the starting switch is operated. If the charging connector is connected to a vehicle which has communication function for communicating with the charging apparatus, the controller controls so that a voltage is applied to the charging connector in accordance with the communication between the communication device and the vehicle.

Other aspects and advantages of the invention will become apparent from the following description, taken in conjunction with the accompanying drawings, illustrating by way of example the principles of the invention.

### BRIEF DESCRIPTION OF THE DRAWINGS

The invention together with objects and advantages thereof, may best be understood by reference to the following description of the presently preferred embodiments together with the accompanying drawings in which:

FIG. 1 is a schematic view showing a charging station according to a first embodiment of the present invention;

FIG. 2 is an electric diagram showing the circuit of the charging station of FIG. 1;

FIG. 3 is a timing chart of the charging station of FIG. 1;

FIG. 4 is a flow chart illustrating the operation of the charging station of FIG. 1;

FIG. 5 is an electric diagram showing the circuit of a charging station according to a second embodiment of the present invention;

FIG. 6 is a flow chart illustrating the operation of the charging station of FIG. 5;

FIG. 7 is a flow chart illustrating the operation of a charging station according to a third embodiment of the present invention; and

FIG. 8 is a schematic view showing a charging station according to background art.

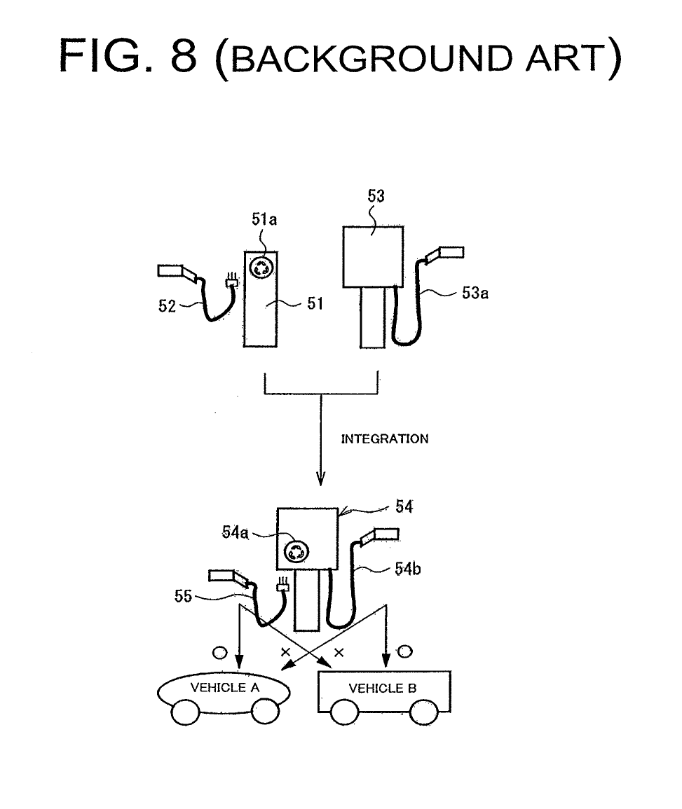

### DETAILED DESCRIPTION OF THE PREFERRED EMBODIMENTS

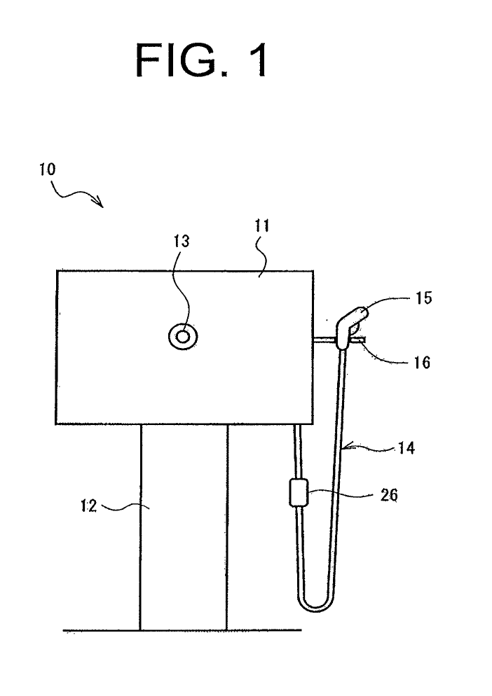

The following will describe a charging station 10 according to the first embodiment of the present invention with reference to FIGS. 1 through 4. Referring to FIG. 1 showing the charging station 10 as a charging apparatus in schematic view, it includes a body 11 and a support 12 that is fixed to the body 11 and stands on the ground. A starting switch 13 is provided approximately at the center of the front surface of the body 11. A flexible undetachable cable 14 is provided extending from a side surface of the body 11. One end of the undetachable cable 14 is fixed to the body 11 and the other end thereof has a standardized charging connector 15 that is connectable to a vehicle. A holder 16 is mounted on the side surface of the body 11, on which the charging connector 15 may be hung. The undetachable cable 14 has a charging circuit interrupt device (CCID) 26.

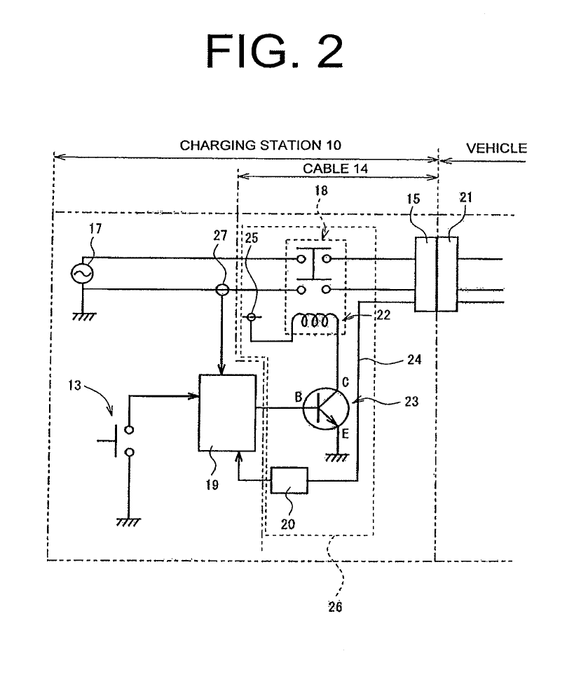

Referring to FIG. 2 showing the electric diagram of the charging station 10, it includes an alternating-current source (AC source) 17, a relay 18, a microcomputer 19 and a control pilot circuit 20, as well as the aforementioned undetachable cable 14, the charging connector 15 and the starting switch 13. The AC source 17 is connected to the undetachable cable 14 at a position adjacent to the proximal end of the undetachable cable 14. The charging connector 15 is mounted to the undetachable cable 14 at the distal end thereof. The relay 18 is located in a pair of electric power lines between the charging connector 15 and the AC source 17. The microcomputer 19 performs ON-OFF control of the relay 18. The starting switch 13 is connected to the microcomputer 19. The control pilot circuit 20 is connected to the microcomputer 19 and is operable to communicate with the vehicle. The microcomputer 19 serves as the controller of the present invention and the control pilot circuit 20 as the communication device of the present invention.

The charging connector 15 is connectable to a vehicle connector 21. The AC source 17 is a power source that supplies alternating-current power (AC power) to a vehicle storage battery (not shown) via the charging connector 15. The relay 18 has therein a solenoid coil 22 connected to the microcomputer 19 through a transistor 23 for opening and closing the relay 18. As shown in FIG. 2, the solenoid coil 22 is connected to a collector (C) of the transistor 23 and the microcomputer 19 is connected to a base (B) of the transistor 23. When current flows through the base (B) based on a control signal from the microcomputer 19, a current flows between the collector (C) and an emitter (E) and hence through the solenoid coil 22 and the relay 18 is turned ON. Then, AC power is supplied to the charging connector 15 from the AC source 17 and further to the vehicle. On the other hand, when no current flows through the base (B), no current flows between the collector (C) and the emitter (E), so that the relay 18 remains OFF and, therefore, no power is supplied to the charging connector 15. Thus, the transistor 23 performs ON-OFF control of the relay 18.

The microcomputer 19 is connected to the starting switch 13 and operable by power supplied from the AC source 17. The starting switch 13 is a self-reset selector switch which is ON while it is held pushed and OFF while it is released. When the starting switch 13 is turned ON, a pulse signal is sent to the microcomputer 19. In response to such a pulse signal, the microcomputer 19 controls the transistor 23 so that a current flows through the base (B) of the transistor 23. Thus, the relay 18 is turned ON. A current sensor 27 that serves as a sensor is provided in the charging station 10 for detecting the charging state, and the current sensor 27 generates a detection signal to the microcomputer 19.

The control pilot circuit 20 has therein a pulse signal generator and is operable by power supplied from the AC source 17 as in the case of the microcomputer 19. The control pilot circuit 20 sends a pilot signal CPLT to a vehicle communication device (not shown) through a control pilot line 24. The pulse width of the pilot signal CPLT informs the vehicle, for example, of the capacity of current supplied by the charging station 10. Thus, charging information is communicated between the control pilot circuit 20 and the vehicle communication device. When charging preparation is completed on the vehicle side and the vehicle is switched ON, the pulse voltage of the pilot signal CPLT of the control pilot circuit 20 is dropped. The control pilot circuit 20 detects the voltage drop within the circuit and controls such that a current flows through the base (B) of the transistor 23 via the microcomputer 19 when the pulse voltage of the pilot signal CPLT is lowered below a predetermined voltage V1. Then, the relay 18 is turned ON. The CUD 26 includes the relay 18 and the control pilot circuit 20.

When the relay 18 is turned ON by the ON operation of the starting switch 13 or the pilot signal CPLT from the control pilot circuit 20, AC power is supplied to the charging connector 15 for supplying power to the vehicle. In charging a vehicle having no communication function and supported by the mode 1 charging, the charging connector 15 is connected to the vehicle and the starting switch 13 is turned ON. By so doing, power is supplied to the charging connector 15 for charging the storage battery. In charging a vehicle having communication function and supported by the mode 2 or 3 charging, charging information is automatically communicated between the control pilot circuit 20 and the vehicle regardless of the operation of the starting switch 13 by connecting the charging connector 15 to the vehicle. In accordance with the charging information, AC power is supplied to the charging connector 15 for charging the storage battery.

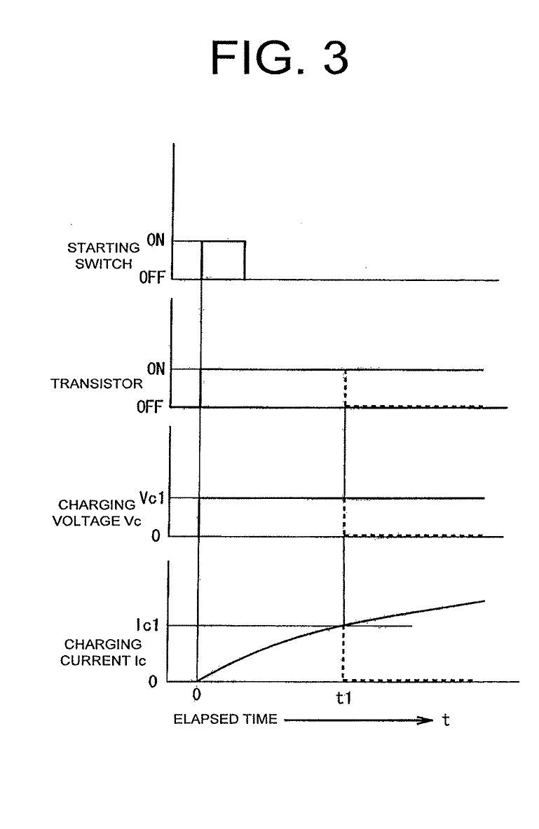

Reference is made to the timing chart of FIG. 3 showing variation of charging current and charging voltage in accordance with the operation of the starting switch 13. When the charging connector 15 of the undetachable cable 14 is connected to the vehicle connector 21 and the starting switch 13 is turned ON, a pulse signal is sent to the microcomputer 19. It is noted that the charging voltage applied to the charging connector 15 is represented by reference symbol Vc and the charging current flowing through the charging connector 15 is represented by reference symbol Ic. In response to the pulse signal, the microcomputer 19 turns ON the transistor 23 and hence the relay 18, thus AC power being supplied to the charging connector 15. As shown in FIG. 3, the charging voltage Vc then rises to Vc1 and the charging current Ic is increased with elapsed time t.

It is noted that the value of the charging current at the elapsed time t1 is Ic1 as shown in FIG. 3 and a preset threshold value used for determining whether or not charging is started will be represented by Ic0. If Ic1≧Ic0 at the elapsed time t1, the microcomputer 19 determines that the vehicle is being charged and the charging is continued at the charging voltage Vc1. If Ic1<Ic0 at the elapsed time t1, on the other hand, the microcomputer 19 determines that the vehicle is not being charged and, therefore, no charging voltage Vc is applied to the charging connector 15. The charging current Ic is detected by the current sensor 27. The elapsed time t1 is set longer than the time that is taken to start charging any vehicle. The determination by comparing the charging current Ic1 and the threshold current Ic0 is automatically performed in accordance with the program stored in the microcomputer 19. The solid lines of FIG. 3 indicate charging being continued and the broken lines of FIG. 3 indicate charging being stopped.

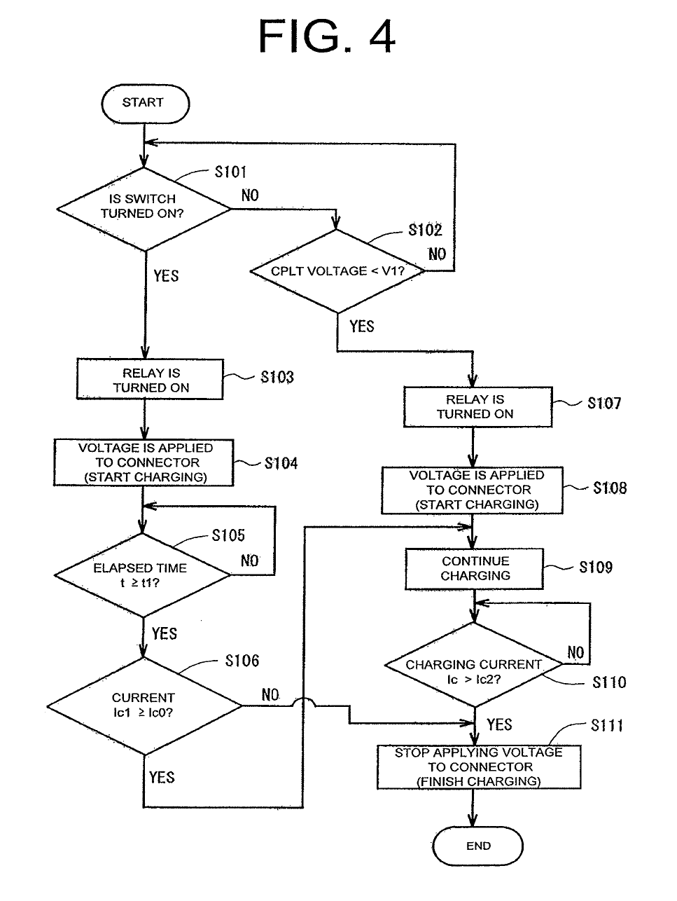

The following will describe the operation of the charging station 10 with reference to the flow chart of FIG. 4. The vehicle is initially parked near the charging station 10 before starting the charging operation. One that operates the charging station 10 (hereinafter referred to as user) removes the charging connector 15 from the holder 16 of the charging station 10 and pulls out the undetachable cable 14 to connect the charging connector 15 to the vehicle connector 21.

At step S101, the microcomputer 19 determines whether or not the starting switch 13 on the body 11 of the charging station 10 is turned ON. If YES, i.e. if the starting switch 13 is turned ON, a pulse signal that is indicative of the starting switch 13 being ON is sent to the microcomputer 19, which then turns ON the transistor 23. As a result, the relay 18 is turned ON at step S103. If NO at step S101, the microcomputer 19 determines at step S102 whether or not the pulse voltage of the pilot signal CPLT is lower than the aforementioned predetermined voltage V1.

At step S104, the AC source 17 is connected to the undetachable cable 14 and, therefore, the charging voltage Vc1 is applied to the charging connector 15. Thus, the charging station 10 starts charging the vehicle by supplying power to the storage battery. Then at step S105, the microcomputer 19 determines whether or not the elapsed time t has reached t1 since the starting switch 13 was turned ON. If YES, or t≧t1, the microcomputer 19 determines at step S106 whether or not the detected charging current Ic1 has reached the aforementioned preset threshold current Ic0. If NO, or t<t1, the step S105 is repeated until the microcomputer 19 determines t≧t1. At step S106, if the microcomputer 19 determines that the detected charging current Ic1 has reached the preset threshold charging current Ic0, the charging station 10 continues to charge the vehicle.

On the other hand, if YES at step S102, or if the microcomputer 19 determines that the pulse voltage of the pilot signal CPLT is lower than the predetermined voltage V1, the transistor 23 is turned ON in accordance with the control signal from the control pilot circuit 20 thereby to turn ON the relay 18, as indicated at step S107. If NO at step S102, or if the microcomputer 19 determines that the pulse voltage of the pilot signal CPLT is V1 or higher, the control moves back from step S102 to step S101 as indicated by the arrow of NO. At step S108, the AC source 17 is connected to the undetachable cable 14 and, therefore, the charging voltage Vc1 is applied to the charging connector 15. Thus, the charging station 10 starts charging the vehicle by supplying power to the storage battery.

Then, at step S109, the charging station 10 continues to charge the vehicle. At step S110, the microcomputer 19 determines whether or not the charging current Ic is larger than a predetermined current Ic2. If YES, or if Ic>Ic2, applying the charging voltage Vc1 to the charging connector 15 is stopped at step S111. Thus, vehicle charging by the charging station 10 ends. If NO at step S110, or if Ic≦Ic2, the step S110 is repeated until the microcomputer 19 determines Ic>Ic2. After the charging station 10 has finished charging the vehicle, the user removes the charging connector 15 from the vehicle and returns it to the holder 16 of the charging station 10.

The charging station 10 of the first embodiment offers the following advantageous effects.

(1) The charging station 10 includes the undetachable cable 14 having the standardized charging connector 15, the microcomputer 19 that is connected to the starting switch 13 and controls power supply from the AC source 17, and the control pilot circuit 20 that communicates with the vehicle in accordance with the pilot signal CPLT and controls power supply from the AC source 17. In charging a vehicle having no communication function and supported by the mode 1 charging, the charging connector 15 is connected to the vehicle and the starting switch 13 is turned ON. By so doing, power is supplied to the charging connector 15 for charging the storage battery. In charging a vehicle having communication function and supported by the mode 2 or 3 charging, charging information is automatically communicated between the control pilot circuit 20 and the vehicle regardless of the operation of the starting switch 13 by connecting the charging connector 15 to the vehicle. In accordance with the charging information, AC power is supplied to the charging connector 15 for charging the storage battery. Thus, the provision of the undetachable cable 14 having the standardized charging connector 15 and the starting switch 13 in the charging station 10 makes possible charging any vehicle supported by any of the modes 1 to 3 charging, merely by connecting the charging connector 15 to the vehicle.
(2) If the microcomputer 19 determines that the detected charging current Ic1 has reached the threshold charging current Ic0 at the elapsed time t1 after the starting switch 13 is turned ON, the charging station 10 continues to charge at the charging voltage Vc1. If the microcomputer 19 determines that the detected charging current Ic1 has not reached the threshold charging current Ic0 at the elapsed time t1 after the starting switch 13 is turned ON, the microcomputer 19 stops applying the charging voltage Vc to the charging connector 15. For example, the user may leave the charging connector 15 unused and placed on the ground without following the normal procedure of connecting the charging connector 15 to the vehicle and then turning ON the starting switch 13. In this case, the relay 18 is opened after the elapsed time t1, so that no further charging voltage Vc is applied to the charging connector 15 and any trouble with the charging operation is forestalled.
(3) The elapsed time V1 is set sufficiently longer than time taken before charging of a vehicle is started. Thus, wrong control such that the charging voltage Vc is interrupted while charging of the vehicle is not completely started due to particular specification depending on the vehicle is prevented.
(4) The user may not be aware of the modes 1 to 3 charging in connection with the vehicle that is to be charged. Such user may be instructed to connect the charging connector 15 to the vehicle and then turn ON the starting switch 13.

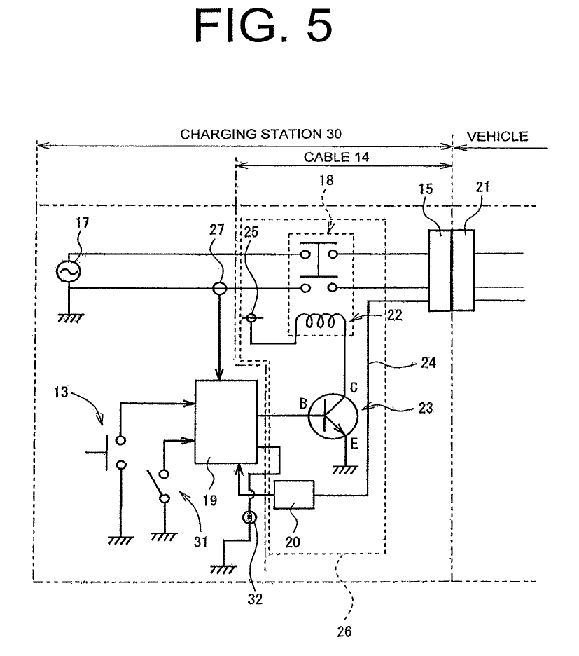

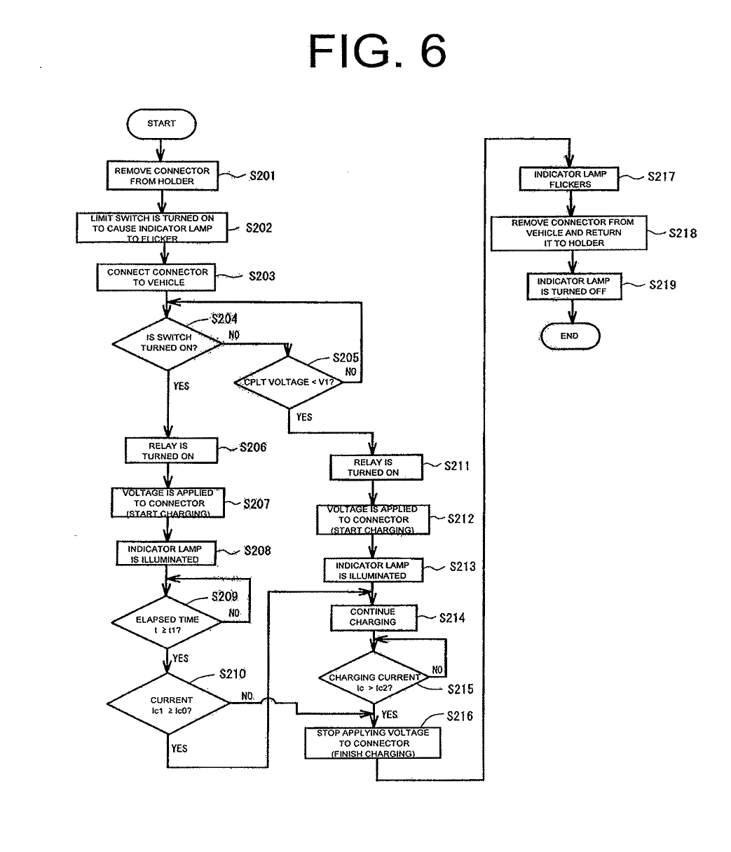

The following will describe a charging station 30 according to the second embodiment of the present invention with reference to FIGS. 5 and 6. The second embodiment differs from the first embodiment in that a limit switch 31 and an indicator lamp 32 are connected to the microcomputer 19 as shown in FIG. 5. The rest of the structure of the second embodiment is substantially the same as that of the first embodiment. For the sake of convenience of explanation, therefore, like or same parts or elements will be referred to by the same reference numerals as those which have been used in the first embodiment, and the description thereof will be omitted.

The limit switch 31 is provided in the holder 16 of the charging station 30, serving as the detecting device of the present invention for detecting the removal of the charging connector 15 from the holder 16. The limit switch 31 is turned OFF, or opened, when the charging connector 15 is hung by the holder 16. The limit switch 31 is turned ON, or closed, when the charging connector 15 is removed from the holder 16. The indicator lamp 32 indicates the application of a voltage to the charging connector 15, serving as the indicator of the present invention. The starting switch 13 is an illustrated switch, that is, the indicator lamp 32 is built in the starting switch 13.

When the charging connector 15 is removed from the holder 16, the limit switch 31 is turned ON thereby to send an ON signal to the microcomputer 19. Receiving the ON signal from the limit switch 31, the microcomputer 19 causes the indicator lamp 32 to flicker, indicating that no voltage is applied to the charging connector 15. The microcomputer 19 keeps the indicator lamp 32 to be illuminated when a voltage is applied to the charging connector 15.

In the case of a vehicle supported by the mode 1 charging, when the charging connector 15 is removed from the holder 16, the limit switch 31 is turned ON thereby to cause the indicator lamp 32 to flicker. At this point, no voltage is applied to the charging connector 15. The charging connector 15 is connected to the vehicle and then the starting switch 13 is turned ON. By so doing, a voltage is applied to the charging connector 15 thereby to cause the indicator lamp 32 to be illuminated. In the case of a vehicle supported by the mode 2 or 3 charging, when the charging connector 15 is removed from the vehicle, the limit switch 31 is turned ON and the indicator lamp 32 flickers, indicating that no voltage is applied to the charging connector 15. Then, charging information is automatically communicated between the control pilot circuit 20 and the vehicle, so that a voltage is applied to the charging connector 15 and the indicator lamp 32 is illuminated.

The following will describe the operation of the charging station 30 of the second embodiment with reference to the flow chart shown by FIG. 6. At step S201, the charging connector 15 is removed from the holder 16 of the charging station 30. Then, at the next step S202, the limit switch 31 is turned ON thereby to cause the indicator lamp 32 to flicker. At this point, no voltage is applied to the charging connector 15. Then, at step S203, the charging connector 15 is connected to the vehicle connector 21.

Since steps S204 to S207 of FIG. 6 are substantially the same as steps S101 to S104 of FIG. 4, the description thereof will be omitted. At step S208, the indicator lamp 32 is illuminated because the charging voltage Vc1 is applied to the charging connector 15 at step S207. Since steps S205, S211 and S212 of FIG. 6 are substantially the same as steps S102, S107 and S108 of FIG. 4, the description thereof will be omitted. At step S213, the indicator lamp 32 is illuminated because the charging voltage Vc1 is applied to the charging connector 15 at step S212.

Since steps S209, S210 and steps S214 to S216 of FIG. 6 are substantially the same as steps S105, S106 and steps S109 to S111 of FIG. 4, the description thereof will be omitted. At step S217, illumination of the indicator lamp 32 is changed to flickering because application of the charging voltage Vc1 to the charging connector 15 is stopped at the preceding step S216. At step S218, the charging connector 15 is removed from the vehicle and hung by the holder 16 of the charging station 30. At step S219, the limit switch 31 is turned OFF thereby to turn OFF the indicator lamp 32.

As is apparent from the foregoing, the user may visually recognize from illumination or flickering of the indicator lamp 32 whether or not the vehicle is being charged, which improves the usability of the charging station 30. In addition, the use of the limit switch 31 which directly detects the removal of the charging connector 15 from the holder 16 of the charging station 30 improves the reliability of detection.

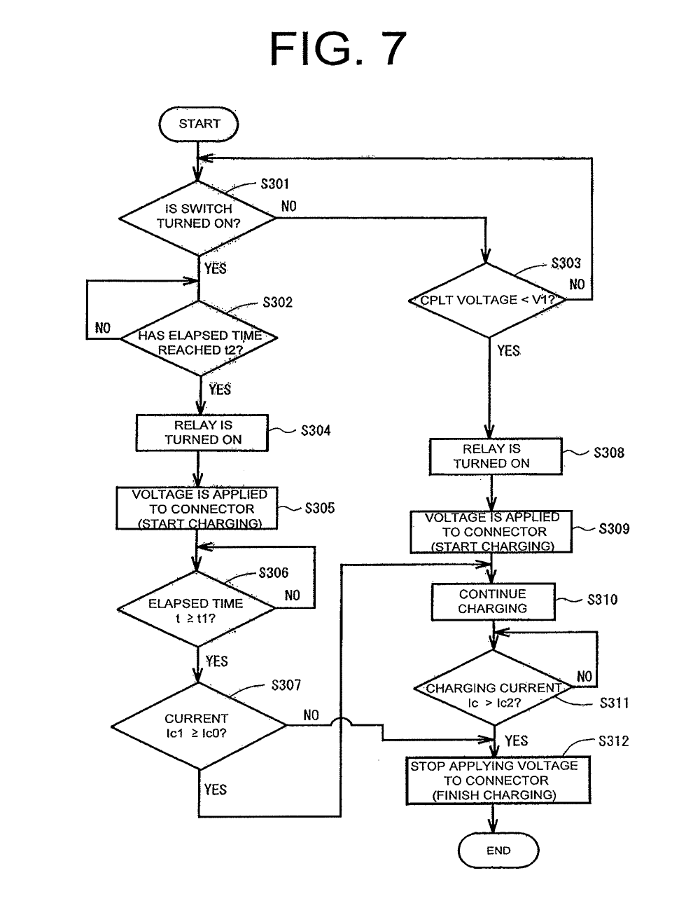

The following will describe the charging station according to the third embodiment of the present invention with reference to FIG. 7. The third embodiment differs from the first embodiment in the time when voltage is applied to the charging connector 15. The rest of the structure of the third embodiment is substantially the same as that of the first embodiment. For the sake of convenience of explanation, therefore, like or same parts or elements will be referred to by the same reference numerals as those which have been used in the first embodiment, and the description thereof will be omitted.

As shown in FIG. 7, at step S301 the microcomputer 19 determines whether or not the starting switch 13 is turned ON. If YES, the microcomputer 19 then determines at step S302 whether or not the elapsed time t has reached t2 since the starting switch 13 was turned ON. If YES, the transistor 23 is turned ON thereby to turn ON the relay 18 at step S304. If NO at step S302, the determination whether or not the elapsed time t has reached t2 since the turning ON of the starting switch 13 is repeated. It is noted that the microcomputer 19 has a delay circuit with timer function. Therefore, when the starting switch 13 is turned ON, the delay circuit starts counting and the relay 18 is turned ON after an elapse of a predetermined length of time such as t2. Thus, alternating voltage is applied to the charging connector 15. If the standard time taken by the user to connect the charging connector 15 to the vehicle after the starting switch 13 is turned ON is t0, t2 is preset to meet the requirement t2>t0.

The flow chart of the third embodiment shown in FIG. 7 differs from that of FIG. 4 of the first embodiment in that step S302 is added. Specifically, a step for determining whether or not the elapsed time t has reached t2 is added between the steps S101 and S103 of FIG. 4. The other steps of the third embodiment are substantially the same as those of the first embodiment, and the description thereof will be omitted.

Some user may move to connect the charging connector 15 to the vehicle after turning ON the starting switch 13. It is different from the normal procedure which turns ON the starting switch 13 after connecting the charging connector 15 to the vehicle. Even if the user takes the adverse action, alternating voltage is applied to the charging connector 15 after the elapsed time t2. That is, no voltage is applied to the charging connector 15 before the charging connector 15 is connected to the vehicle. Thus, charging safety is improved.

The present invention has been described in the context of the above-described first through third embodiments, but it is not limited to those embodiments. It is obvious to those skilled in the art that the invention may be practiced in various manners as exemplified below.

Although in the second embodiment the limit switch 31 is used as the detecting device of the present invention, a user authentication device may be provided in the charging station 30 for use as the detecting device. In this case, removal of the charging connector 15 from the holder 16 is previously detectable from user authentication by the user authentication device (for example, by inserting a card having recorded therein private information into the user authentication device). In this case, it is not necessary to provide the limit switch 31 in the holder 16 and, therefore, the charging station can be simplified.

Although in the second embodiment the starting switch 13 has therein the built-in indicator lamp 32, a separate lamp may be provided on the charging station 30. Alternatively, any other indicator such as a buzzer may be used instead of the indicator lamp 32.

What is claimed is:

1. A charging apparatus supplying power from a power source to a vehicle, the charging apparatus comprising:
a body;
a cable, one end of which is fixed to the body and the other end of which has a standardized charging connector that is connectable to the vehicle;
a communication device for communicating charging information with the vehicle which has communication function for communicating with the charging apparatus;
a starting switch provided in the body for starting charging the vehicle; and
a controller connected to the communication device and the starting switch for controlling the power supply from the power source to the charging connector, wherein if the charging connector is connected to a vehicle which has no communication function for communicating with the charging apparatus, the controller controls so that a voltage is applied to the charging connector when the starting switch is operated, wherein if the charging connector is connected to a vehicle which has communication function for communicating with the charging apparatus, the controller controls so that a voltage is applied to the charging connector in accordance with the communication between the communication device and the vehicle.

2. The charging apparatus according to claim 1, further comprising a sensor for detecting that charging is being performed and transmitting a detection signal to the controller, wherein if the sensor does not detect that charging is being performed when a predetermined time has passed since the starting switch was operated, the controller controls so that no further voltage is applied to the charging connector.

3. The charging apparatus according to claim 1, further comprising a delay circuit provided in the controller in such a way that a voltage is applied to the charging connector when a predetermined time has passed since the starting switch was operated.

4. The charging apparatus according to claim 1, wherein the charging apparatus is a charging station for charging a storage battery of the vehicle, the charging station including a power source for supplying power.

5. The charging apparatus according to claim 1, further comprising:
a holder for holding the charging connector;
a detecting device for detecting removal of the charging connector from the holder; and
an indicator for indicating application of a voltage to the charging connector, wherein after the detecting device detects the removal of the charging connector from the holder, the indicator differently indicates whether or not a voltage is applied to the charging connector.

6. The charging apparatus according to claim 5, wherein the indicator is an indicator lamp, wherein when the charging connector is removed from the holder and no voltage is applied to the charging connector, the indicator lamp flickers, wherein when the charging connector is removed from the holder and a voltage is applied to the charging connector, the indicator lamp is illuminated.

7. The charging apparatus according to claim 5, wherein the detecting device is a user authentication device for authenticating a user.
